(19) United States
(12) Patent Application Publication
(10) Pub. No.: US 2025/0199124 A1
(43) Pub. Date: Jun. 19, 2025

(54) DATA PROCESSING METHOD AND DEVICE

(71) Applicant: Silicon Optronics, Inc., Hsinchu (TW)

(72) Inventors: Qingfeng LI, Hsinchu (TW); Xinping HE, Hsinchu (TW); Xiaodong LUO, Hsinchu (TW)

(21) Appl. No.: 18/669,894

(22) Filed: May 21, 2024

(30) Foreign Application Priority Data
Dec. 13, 2023 (CN) 202311713518.5

(51) Int. Cl. G01S 7/48; G01S 7/481

(52) U.S. Cl. CPC G01S 7/4808; G01S 7/4816

(57) ABSTRACT

A data processing method that is suitable for use in a time-of-flight sensor includes the following steps. A processing unit reads a first stage of time-slot counting data corresponding to the time-of-flight sensor from a storage unit. The processing unit generates an overflow warning signal according to the first time-slot counting data and a first predetermined threshold. The processing unit reads a second stage of time-slot counting data, wherein the second time-slot counting data are greater than or equal to the first time-slot counting data, and the second time-slot counting data are generated by the time-of-flight sensor performing a sensing operation based on the first time-slot counting data. The processing unit subtracts a second predetermined threshold from the second time-slot counting data to generate a third stage of time-slot counting data or maintains the second time-slot counting data according to the overflow warning signal.

### CROSS REFERENCE TO RELATED APPLICATIONS

This application claims priority of China Patent Application No. 202311713518.5, filed on Dec. 13, 2023, the entirety of which is incorporated by reference herein.

### BACKGROUND OF THE INVENTION

### Field of the Invention

The present invention relates to a data processing method and a processing device, and in particular it relates to a data processing method and device suitable for use in a time-of-flight sensor.

### Description of the Related Art

In general, time-of-flight sensors (such as a single-photon avalanche diode (SPAD) sensor) may be used to sense the distance to a target object. When light irradiates into the time-of-flight sensor to cause the time-of-flight sensor to be triggered, the time-of-flight sensor may generate an avalanche effect, causing the output signal of the time-of-flight sensor to toggle. The time-of-flight sensor may accumulate (for example, add “1”) the value of the time slot corresponding to the time when the signal toggles. However, when the accumulated value reaches its maximum value, it will not continue to count. This may cause the signal-to-noise ratio of the time-of-flight sensor to decrease, and cause the sensing signal to lose accuracy, making it inconvenient to use.

Therefore, how to effectively prevent the value of the time-slot counting data corresponding the time-of-flight sensor from reaching its maximum value and being unable to continue counting (which may cause the sensing signal to lose accuracy due to the decrease in the signal-to-noise ratio of the time-of-flight sensor) has become a focus of technical improvements.

### BRIEF SUMMARY OF THE INVENTION

An embodiment of the present invention provides a data processing method and a data processing device which prevent the value of the time-slot counting data that correspond to a time-of-flight sensor from reaching a maximum value and thereby being unable to continue counting (which can cause the sensing signal to lose accuracy due to the decrease in the signal-to-noise ratio of the time-of-flight sensor), and thereby increasing the convenience of use.

An embodiment of the present invention provides a data processing method suitable for use in a time-of-flight sensor. The data processing method includes the following steps. A processing unit is used to read a first stage of time-slot counting data corresponding to the time-of-flight sensor from a storage unit. The processing unit is used to generate an overflow warning signal according to the first time-slot counting data and a first predetermined threshold. The processing unit is used to read a second stage of time-slot counting data, wherein the second stage of time-slot counting data are greater than or equal to the first stage of time-slot counting data, and the second stage of time-slot counting data are generated by the time-of-flight sensor performing a sensing operation based on the first stage of time-slot counting data. The processing unit is used to subtract a second predetermined threshold from the second stage of time-slot counting data to generate a third stage of time-slot counting data or to maintain the second stage of time-slot counting data according to the overflow warning signal.

An embodiment of the present invention provides a data processing device suitable for use in a time-of-flight sensor. The data processing device includes a storage unit and a processing unit. The storage unit is configured to record a first stage of time-slot counting data and a second stage of time-slot counting data corresponding to the time-of-flight sensor, wherein the second stage of time-slot counting data are greater than or equal to the first stage of time-slot counting data, and the second stage of time-slot counting data are generated by the time-of-flight sensor performing a sensing operation based on the first stage of time-slot counting data. The processing unit is coupled to the storage unit. The processing unit is configured to read the first stage of time-slot counting data. The processing unit is configured to generate an overflow warning signal according to the first stage of time-slot counting data and a first predetermined threshold. The processing unit is configured to read the second stage of time-slot counting data. The processing unit is configured to subtract a second predetermined threshold from the second stage of time-slot counting data to generate a third stage of time-slot counting data or to maintain the second stage of time-slot counting data according to the overflow warning signal.

According to the data processing method and the data processing device disclosed by the present invention, the processing unit reads the first stage of time-slot counting data corresponding to the time-of-flight sensor from the storage unit. The processing unit generates the overflow warning signal according to the first stage of time-slot counting data and the first predetermined threshold. The processing unit reads the second stage of time-slot counting data, wherein the second stage of time-slot counting data are greater than or equal to the first stage of time-slot counting data, and the second stage of time-slot counting data are generated by the time-of-flight sensor performing a sensing operation based on the first stage of time-slot counting data. The processing unit subtracts the second predetermined threshold from the second stage of time-slot counting data to generate the third stage of time-slot counting data or maintains the second stage of time-slot counting data according to the overflow warning signal. Therefore, it may effectively prevent the value of the time-slot counting data corresponding the time-of-flight sensor from reaching the maximum value and being unable to continue counting, which may cause the signal-to-noise ratio of the time-of-flight sensor to decrease and inaccurate sensing signal, and increasing the convenience of use.

### BRIEF DESCRIPTION OF THE DRAWINGS

The present invention can be more fully understood by reading the subsequent detailed description and examples with references made to the accompanying drawings, wherein:

FIG. 1 is a schematic view of a data processing device according an embodiment of the present invention;

FIG. 2 is a schematic view of a processing unit according an embodiment of the present invention;

FIG. 3 is a flowchart of a data processing method according an embodiment of the present invention;

FIG. 4 is a detailed flowchart of step S304 in FIG. 3; and

FIG. 5 is a flowchart of a data processing method according another embodiment of the present invention.

### DETAILED DESCRIPTION OF THE INVENTION

In each of the following embodiments, the same reference number represents an element or component that is the same or similar.

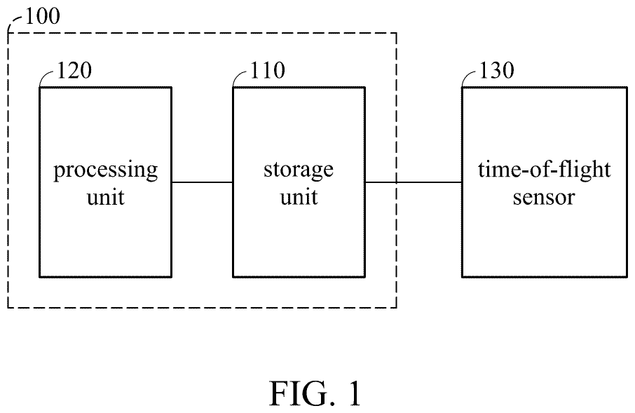

FIG. 1 is a schematic view of a data processing device according an embodiment of the present invention. The data processing device 100 of the embodiment is suitable for use in a time-of-flight sensor 130. In the embodiment, the time-of-flight sensor 130 is, for example, a single-photon avalanche diode (SPAD) sensor. When the light irradiates into the time-of-flight sensor 130 (such as the SPAD sensor) to cause the time-of-flight sensor 130 (such as the SPAD sensor) to be triggered, the time-of-flight sensor 130 (such as the SPAD sensor) may generate an avalanche effect and convert photons to generate small amount of electrons, and the above avalanche effect may cause the output signal of the time-of-flight sensor 130 (such as SPAD sensor) to toggle. The time-of-flight sensor 130 (such as SPAD sensor) may accumulate the value of the time slot corresponding to the time when the signal toggles according to the time when the above signal toggles, so as to generate corresponding time-slot counting data.

For example, assuming that the time when the signal toggles is 1 nanosecond (ns), the time-of-flight sensor 130 may accumulate (for example, add “1”) the value of the time slot (1 ns) corresponding to the time when the signal toggles (1 ns), so as to generate corresponding time-slot counting data. Assuming that the time when the signal toggles is 5 ns, the time-of-flight sensor 130 may accumulate (for example, add “1”) the value of the time slot (5 ns) corresponding to the time when the signal toggles, so as to generate corresponding time-slot counting data. The rest of the time-slot counting data may be deduced by analogy.

Please refer to FIG. 1. The data processing device 100 may include a storage unit 110 and a processing unit 120. The storage unit 110 may record a first stage of time-slot counting data and a second stage of time-slot counting data corresponding to the time-of-flight sensor 130. In the embodiment, the second stage of time-slot counting data are, for example, greater than or equal to the first stage of time-slot counting data, and the second stage of time-slot counting data are generated by the time-of-flight sensor 130 performing a sensing operation based on the first stage of time-slot counting data.

For example, the time-of-flight sensor 130 preforms N light sensing operations and accumulates the values of the time slots corresponding to the times when the signals toggle, so as to generate the first stage of time-slot counting data, and the first stage of time-slot counting data may be recorded in the storage unit 110. Then, the time-of-flight sensor 130 may perform N light sensing operations based on the first stage of time-slot counting data, and accumulate the values of the time slots corresponding to the times when the signals toggle, so as to generate the second stage of time-slot counting data, and the second stage of time-slot counting data may be recorded in the storage unit 110. That is, the second stage of time-slot counting data may be data generated by accumulating the first stage of time-slot counting data. In some embodiments, the storage unit 110 is, for example, a static random access memory (SRAM), but the embodiment of the present invention is not limited thereto.

The processing unit 120 may be coupled to the storage unit 110. The processing unit 120 is, for example, a micro control unit (MCU), a microprocessor or a central processing unit (CPU), but the embodiment of the present invention is not limited thereto.

The processing unit 120 may read the first stage of time-slot counting data from the storage 110. That is, the processing unit 120 may read the first stage of time-slot counting data from the storage 110 after the time-of-flight sensor 130 performs N light sensing operations. Then, the processing unit 120 may generate an overflow warning signal according to the first stage of time-slot counting data and a first predetermined threshold. In some embodiments, the first predetermined threshold is, for example, 1024 or 2048, but the embodiment of the present invention is not limited thereto.

Furthermore, after the processing unit 120 obtains the first stage of time-slot counting data, the processing unit 120 may compare the first stage of time-slot counting data with the first predetermined threshold to determine whether the first stage of time-slot counting data are greater than or equal to the first predetermined threshold (such as 1024 or 2048), and then generate a corresponding overflow warning signal.

When determining that the first stage of time-slot counting data are greater than or equal to the first predetermined threshold (such as 1024 or 2048), it indicates that the values of all first stage of time-slot counting data are greater than or equal to the first predetermined threshold (such as 1024 or 2048), and the processing unit 120 may generate, for example, the overflow warning signal with a first level. In addition, when determining that the first stage of time-slot counting data are not greater than or equal to the first predetermined threshold (such as 1024 or 2048), it indicates that the value of at least one of the first stage of time-slot counting data is not greater than or equal to the first predetermined threshold (such as 1024 or 2048), and the processing unit 120 may generate, for example, the overflow warning signal with a second level. In the embodiment, the first level is different from the second level, for example. In some embodiments, the first level may be a high logic level, such as “1”, and the second level may be a low logic level, such as “0”, but the embodiment of the present invention is not limited thereto.

In some embodiments, the processing unit 120 may determine whether the most significant bits (MSBs) of the first stage of time-slot counting data are greater than or equal to the first predetermined threshold. That is, after the processing unit 12 reads the first stage of time-slot counting data, the processing unit 120 may obtain the most significant bits of the first stage of time-slot counting data, compare the values of the most significant bits with the first predetermined threshold to determine whether the most significant bits are greater than or equal to the first predetermined threshold, and then generate a corresponding overflow warning signal. In the embodiment, the first predetermined threshold is, for example, “1”.

For example, when the most significant bits of the first stage of time-slot counting data are “1”, the processing unit 120 may determine that the most significant bits “1” of the first stage of time-slot counting data are equal to the first predetermined threshold “1”, and then the processing unit 120 may generate an overflow warning signal with the first level (such as “1”). When the most significant bits of the first stage of time-slot counting data are “0”, the processing unit 120 may determine that the most significant bits “0” of the first stage of time-slot counting data are greater than or equal to the first predetermined threshold “1”, and then the processing unit “1”, and then the processing unit 120 may generate an overflow warning signal with the second level (such as “0”).

Afterward the processing unit 120 may reads the second stage of time-slot counting data from the storage unit 110. That is, the processing unit 120 may reads the second stage of time-slot counting data from the storage unit 110 after the time-of-flight sensor 130 performs N light sensing operations 130 according to the first stage of time-slot counting data.

Then, the processing unit 120 may subtract the second predetermined threshold from the second stage of time-slot counting data to generate the third stage of time-slot counting data or to maintain the second stage of time-slot counting data according to the overflow warning signal. In some embodiments, the above second predetermined threshold is, for example, less than or equal to the first predetermined threshold.

For example, after the processing unit 120 reads the second stage of time-slot counting data and when the overflow warning signal generated by the processing unit 120 is the first level (such as the high logic level “1”), the processing unit 120 may subtract the second predetermined threshold from the second stage of time-slot counting data to generate the third stage of time-slot counting data. That is, the processing unit 120 may subtract the second predetermined threshold from the value of each of the second stage of time-slot counting data to generate the third stage of time-slot counting data, i.e., (the third time-slot counting data—the second time-slot counting data-the second predetermined threshold). Therefore, it may effectively prevent the value of the time-slot counting data corresponding the time-of-flight sensor 130 from reaching the maximum value and being unable to continue counting, which may cause the signal-to-noise ratio of the time-of-flight sensor to decrease and inaccurate sensing signal.

In addition, after the processing unit 120 reads the second stage of time-slot counting data and when the overflow warning signal generated by the processing unit 120 is the second level (such as the low logic level “0”), the processing unit 120 may maintain the second stage of time-slot counting data. That is, the processing unit 120 may not perform any processing on the second stage of time-slot counting data, so as to maintain the original values of the second stage of time-slot counting data.

Afterward, the processing unit 120 may write the second stage of time-slot counting data or the third stage of time-slot counting data into the storage unit 110. Therefore, the time-of-flight sensor 130 may use the second stage of time-slot counting data or the third stage of time-slot counting data as the basis for subsequent sensing operations.

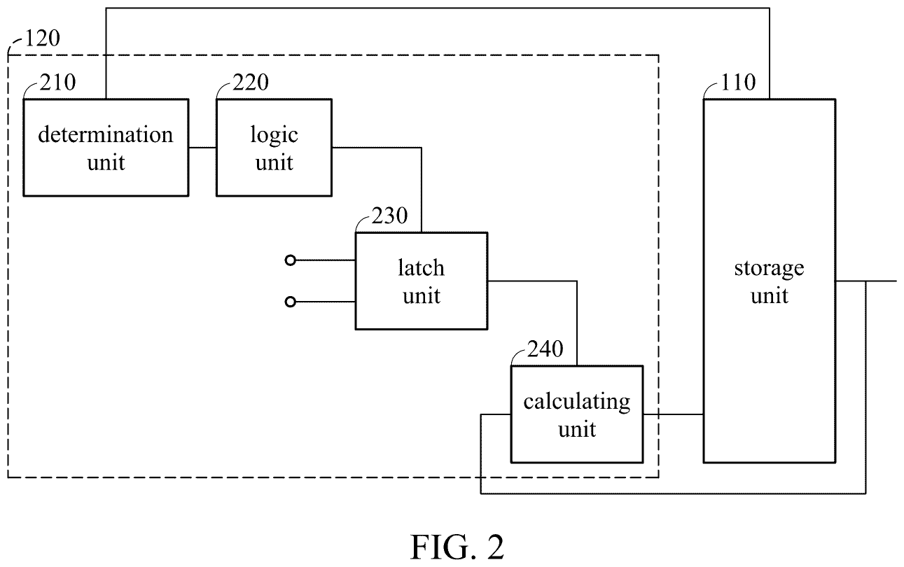

FIG. 2 is a schematic view of a processing unit according an embodiment of the present invention. Please refer to FIG. 2. The processing unit 120 may include a determination unit 210, a logic unit 220, a latch unit 230 and a calculating unit 240.

The determination unit 210 may be coupled to the storage unit 110. The determination unit 210 may read the first stage of time-slot counting data and the first predetermined threshold from the storage unit 110, and generate a determination signal according to the first stage of time-slot counting data and the first predetermined threshold. That is, when the determination unit 210 obtains the first stage of time-slot counting data and the first predetermined threshold, the determination unit 210 may determine whether the first stage of time-slot counting data (or the most significant bits of the first stage of time-slot counting data) are greater than or equal to the first predetermined threshold, so as to generate a corresponding determination signal.

For example, when the first stage of time-slot counting data (or the most significant bits of the first stage of time-slot counting data) are greater than or equal to the first predetermined threshold, the determination unit 210 generates, for example, the determination signal with the high logic level (such as “1”). When the first stage of time-slot counting data (or the most significant bits of the first stage of time-slot counting data) are not greater than or equal to the first predetermined threshold, the determination unit 210 generates, for example, the determination signal with the low logic level (such as “0”).

The logic unit 220 may be coupled to the determination unit 210. The logic unit 220 receives the determination signal and an enabling signal, and generates a logic signal according to the determination signal and the enabling signal. In the embodiment, the enabling signal is, for example, a high logic level, such as “1”. In addition, the logic unit 220 is, for example, an AND gate. That is, the logic unit 220 may perform an “AND” operation on the determination signal and the enabling signal to generate a corresponding logic signal. For example, when the determination signal and the enabling signal are the high logic level (such as “1”), the logic unit 220 may generate the logic signal with the high logic level (such as “1”). When the determination signal is the low logic level (such as “0”) and the enabling signal is the high logic level (such as “1”), the logic unit 220 may generate the logic signal with the low logic level (such as “0”).

The latch unit 230 may be coupled to the logic unit 220. The latch unit 230 receives an initial signal, an input signal and a logic signal, and generates the overflow warning signal according to the initial signal, the input signal and the logic signal. In the embodiment, the latch unit 230 may be a flip-flop (FF). When the logic signal is the high lotic level (such as “1”), the latch unit 230 may generate an overflow warning signal with the high logic level (such as “1”). When the logic signal is the low logic level (such as “0”), the latch unit 230 may generate an overflow warning signal with the low logic level (such as “0”).

The calculating unit 240 may be coupled to the latch unit 230. The calculating unit 240 reads the second stage of time-slot counting data, receives the overflow warning signal, and subtracts a second predetermined threshold from the second stage of time slot counting time-slot counting data to generate a third stage of time-slot counting data or maintains the second stage of time-slot counting data according to the overflow warning signal. In the embodiment, the calculating unit 240 is, for example, a subtractor, but the embodiment of the present invention is not limited thereto. For example, when the overflow warning signal is the high logic level (such as “1”), the calculating unit 240 may subtract the second predetermined threshold from the second stage of time-slot counting data to generate the third stage of time-slot counting data. When the overflow warning signal is the low logic level (such as “0”), the calculating unit 240 may maintain the second stage of time-slot counting data.

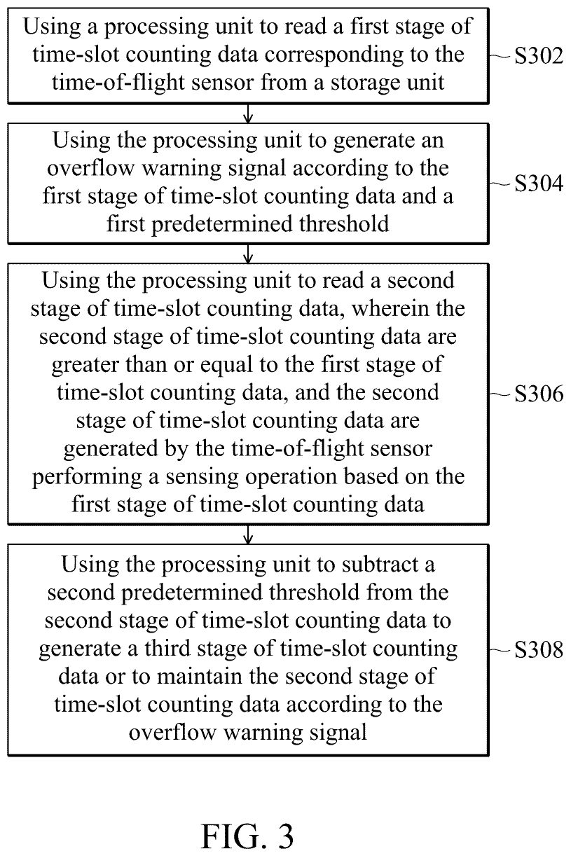

FIG. 3 is a flowchart of a data processing method according an embodiment of the present invention. The data processing method of the embodiment is suitable for use in a time-of-flight sensor. In step S302, the method involves using a processing unit to read a first stage of time-slot counting data corresponding to the time-of-flight sensor from a storage unit. In step S304, the method involves using the processing unit to generate an overflow warning signal according to the first stage of time-slot counting data and a first predetermined threshold.

In step S306, the method involves using the processing unit to read a second stage of time-slot counting data, wherein the second stage of time-slot counting data are greater than or equal to the first stage of time-slot counting data, and the second stage of time-slot counting data are generated by the time-of-flight sensor performing a sensing operation based on the first stage of time-slot counting data. In step S308, the method involves using the processing unit to subtract a second predetermined threshold from the second stage of time-slot counting data to generate a third stage of time-slot counting data or to maintain the second stage of time-slot counting data according to the overflow warning signal. In some embodiments, the above second predetermined threshold is, for example, less than or equal to the first predetermined threshold.

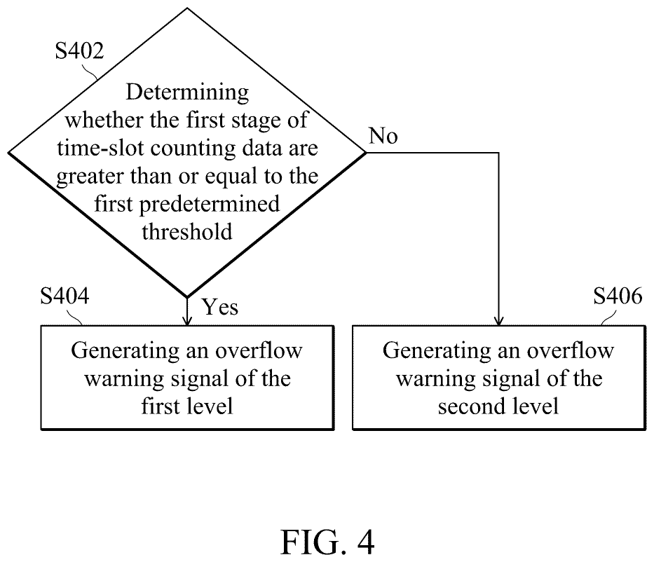

FIG. 4 is a detailed flowchart of step S304 in FIG. 3. In step S402, the method involves determining whether the first stage of time-slot counting data are greater than or equal to the first predetermined threshold. When determining that the first stage of time-slot counting data are greater than the first predetermined threshold, the method performs step S404. In step S404, the method involves generating an overflow warning signal of the first level. When determining that the first stage of time-slot counting data are not greater than or equal to the first predetermined threshold, the method performs steps S406. In step S406, the method involves generating an overflow warning signal of the second level. In the embodiment, the warning signal of first level is different from the second level, for example. In some embodiments, step S402 may include determining whether the most significant bits of the first stage of time-slot counting data are greater than or equal to the first predetermined threshold.

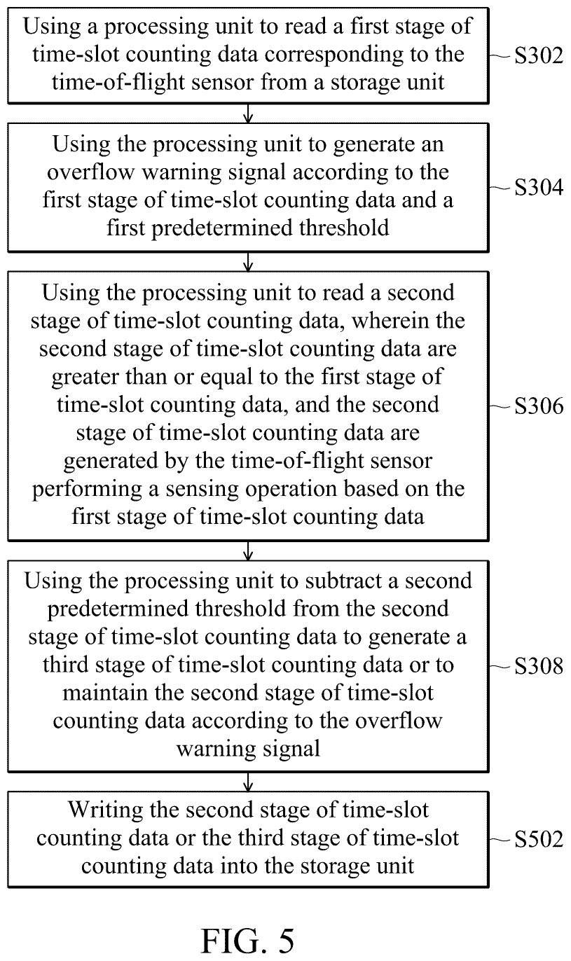

FIG. 5 is a flowchart of a data processing method according another embodiment of the present invention. In the embodiment, steps S302˜S308 in FIG. 5 are the same as or similar to steps S302˜S308 in FIG. 3. Accordingly, steps S302˜S308 in FIG. 5 may refer to description of the embodiment of FIG. 3, and the description thereof is not repeated herein. In step S502, the method involves writing the second stage of time-slot counting data or the third stage of time-slot counting data into the storage unit.

In summary, according to the data processing method and the data processing device disclosed by the embodiment of the present invention, the processing unit reads the first stage of time-slot counting data corresponding to the time-of-flight sensor from the storage unit. The processing unit generates the overflow warning signal according to the first stage of time-slot counting data and the first predetermined threshold. The processing unit reads the second stage of time-slot counting data, wherein the second stage of time-slot counting data are greater than or equal to the first stage of time-slot counting data, and the second stage of time-slot counting data are generated by the time-of-flight sensor performing a sensing operation based on the first stage of time-slot counting data. The processing unit subtracts the second predetermined threshold from the second stage of time-slot counting data to generate the third stage of time-slot counting data or maintains the second stage of time-slot counting data according to the overflow warning signal. Therefore, it may effectively prevent the value of the time-slot counting data corresponding the time-of-flight sensor from reaching the maximum value and being unable to continue counting, which may cause the signal-to-noise ratio of the time-of-flight sensor to decrease and inaccurate sensing signal, and increasing the convenience of use.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A data processing method, suitable for use in a time-of-flight sensor, wherein the data processing method comprises:
using a processing unit to read a first stage of time-slot counting data corresponding to the time-of-flight sensor from a storage unit;
using the processing unit to generate an overflow warning signal according to the first stage of time-slot counting data and a first predetermined threshold;
using the processing unit to read a second stage of time-slot counting data, wherein the second stage of time-slot counting data are greater than or equal to the first stage of time-slot counting data, and the second stage of time-slot counting data are generated by the time-of-flight sensor performing a sensing operation based on the first stage of time-slot counting data; and
using the processing unit to subtract a second predetermined threshold from the second stage of time-slot counting data to generate a third stage of time-slot counting data or to maintain the second stage of time-slot counting data according to the overflow warning signal.

2. The data processing method as claimed in claim 1, wherein the step of generating the overflow warning signal according to the first stage of time-slot counting data and the first predetermined threshold comprises:
determining whether the first stage of time-slot counting data are greater than or equal to the first predetermined threshold;
when determining that the first stage of time-slot counting data are greater than the first predetermined threshold, generating the overflow warning signal with a first level; and
when determining that the first stage of time-slot counting data are not greater than or equal to the first predetermined threshold, generating the overflow warning signal with a second level;
wherein the first level is different from the second level.

3. The data processing method as claimed in claim 2, wherein the step of determining whether the first stage of time-slot counting data are greater than or equal to the first predetermined threshold comprises:
determining whether most significant bits of the first stage of time-slot counting data are greater than or equal to the first predetermined threshold.

4. The data processing method as claimed in claim 1, wherein the second predetermined threshold is less than or equal to the first predetermined threshold.

5. The data processing method as claimed in claim 1, further comprising:
writing the second stage of time-slot counting data or the third stage of time-slot counting data into the storage unit.

6. A data processing device, suitable for use in a time-of-flight sensor, wherein the data processing device comprises:
a storage unit, configured to record a first stage of time-slot counting data and a second stage of time-slot counting data corresponding to the time-of-flight sensor, wherein the second stage of time-slot counting data are greater than or equal to the first stage of time-slot counting data, and the second stage of time-slot counting data are generated by the time-of-flight sensor performing a sensing operation based on the first stage of time-slot counting data; and
a processing unit, coupled to the storage unit, wherein the processing unit is configured to read the first stage of time-slot counting data, the processing unit is configured to generate an overflow warning signal according to the first stage of time-slot counting data and a first predetermined threshold, the processing unit is configured to read the second stage of time-slot counting data, and the processing unit is configured to subtract a second predetermined threshold from the second stage of time-slot counting data to generate a third stage of time-slot counting data or to maintain the second stage of time-slot counting data according to the overflow warning signal.

7. The data processing device as claimed in claim 6, wherein the processing unit is configured to determine whether the first stage of time-slot counting data are greater than or equal to the first predetermined threshold, when determining that the first stage of time-slot counting data are greater than the first predetermined threshold, the processing unit is configured to generate the overflow warning signal with a first level, and when determining that the first stage of time-slot counting data are not greater than or equal to the first predetermined threshold, the processing unit is configured to generate the overflow warning signal with a second level, wherein the first level is different from the second level.

8. The data processing device as claimed in claim 7, wherein the processing unit is further configured to determine whether most significant bits of the first stage of time-slot counting data are greater than or equal to the first predetermined threshold.

9. The data processing device as claimed in claim 6, wherein the processing unit comprises:
a determination unit, configured to read the first stage of time-slot counting data and the first predetermined threshold, and generate a determination signal according to the first stage of time-slot counting data and the first predetermined threshold;
a logic unit, coupled to the determination unit, and configured to receive the determination signal and an enabling signal, and to generate a logic signal according to the determination signal and the enabling signal;
a latch unit, coupled to the logic unit, and configured to receive an initial signal, an input signal and the logic signal, and to generate the overflow warning signal according to the initial signal, the input signal and the logic signal; and
a calculating unit, configured to read the second stage of time-slot counting data, receive the overflow warning signal, and subtract a second predetermined threshold from the second stage of time-slot counting data to generate a third stage of time-slot counting data or to maintain the second stage of time-slot counting data according to the overflow warning signal.

10. The data processing device as claimed in claim 6, wherein the predetermined threshold is less than or equal to the first predetermined threshold.

11. The data processing device as claimed in claim 6, wherein the processing unit is further configured to write the second stage of time-slot counting data or the third stage of time-slot counting data into the storage unit.
